(19) United States
(12) Patent Application Publication
(10) Pub. No.: US 2020/0407209 A1
(43) Pub. Date: Dec. 31, 2020

(54) LIQUID SUPPLY DEVICE AND SYSTEM

(71) Applicant: Changzhou Patent Electronic Technology Co., Ltd., Changzhou City (CN)

(72) Inventors: Weihua Qiu, Changzhou City (CN); Rufeng You, Changzhou City (CN)

(21) Appl. No.: 16/914,431

(22) Filed: Jun. 28, 2020

(30) Foreign Application Priority Data
Jun. 28, 2019 (CN) 201921002956.X

(51) Int. Cl. B67D 7/02; B67D 7/36; A24F 40/10; A24F 40/42; A24F 40/485; A24F 40/51; A24F 40/44

(52) U.S. Cl. CPC B67D 7/0294; B67D 7/36; A24F 40/10; A24F 40/44; A24F 40/485; A24F 40/51; A24F 40/42

(57) ABSTRACT

A liquid supply device for supplying liquid to an atomizing device is provided. The liquid supply device includes a liquid supply member and a connecting member. An inner space of the liquid supply member is a liquid supply chamber containing cigarette liquid. The liquid supply member is provided with a connecting hole. Opposite ends of the connecting member are a liquid inlet end and a liquid outlet end. The liquid inlet end is connected to the connecting hole. An interior of the connecting member is a liquid outlet passage. A control valve is provided on the connecting member. When the atomizing device is installed to the liquid outlet end, by operating the control valve, the liquid outlet passage communicates the liquid supply chamber with the liquid storage chamber, or the liquid supply chamber and the liquid storage chamber are cut off by the control valve.

### TECHNICAL FIELD

The present invention relates to the technical field of simulation smoking, and in particular, to a liquid supply device and a liquid supply system adopting the liquid supply device.

### BACKGROUND

Currently, the atomizing device has become a relatively mature substitute for cigarettes in the market. The atomizing device includes an atomizing main body and a power supply. The atomizing main body includes a liquid storage member with cigarette liquid stored therein and an atomizing structure arranged in the liquid storage member. The atomizing structure heats the cigarette liquid in the liquid storage member under the electric driving of the power supply, and the cigarette liquid is heated to form smoke for the user to suck. Generally, when the user injects cigarette liquid into the atomizing device, the user needs to manually add cigarette liquid into the liquid storage member, which is cumbersome and affects the user's experience.

### SUMMARY

In view of the above, it is necessary to provide a liquid supply device and a liquid supply system adopting the liquid supply device.

A liquid supply device for supplying liquid to an atomizing device is provided. A liquid storage chamber for storing cigarette liquid is provided in the atomizing device. The liquid supply device includes a liquid supply member and a connecting member. An inner space of the liquid supply member is a liquid supply chamber containing cigarette liquid. The liquid supply member is provided with a connecting hole. Opposite ends of the connecting member are respectively a liquid inlet end and a liquid outlet end. The liquid inlet end is connected to the connecting hole and communicated with the liquid supply chamber. An interior of the connecting member is a liquid outlet passage. A control valve is provided on the connecting member. When the atomizing device is installed to the liquid outlet end, by operating the control valve, the liquid outlet passage communicates the liquid supply chamber with the liquid storage chamber, or the liquid supply chamber and the liquid storage chamber are cut off by the control valve.

Further, the liquid supply member and the connecting member are integrally formed.

Further, the liquid supply member is provided with a venting hole communicating the liquid supply chamber with the outside.

Further, the connecting member is a tubular structure made of hard material.

Further, the connecting hole is defined in a sidewall of the liquid supply member, the connecting member is a straight pipe, and the liquid inlet end and the liquid outlet end are located at the same height.

Further, the connecting hole is defined in an upper surface of the liquid supply member, the connecting member is a substantially U-shaped pipe, and the liquid outlet end is located at a lower position relative to the liquid inlet end.

A liquid supply system includes an atomizing device and a liquid supply device configured for supplying liquid to the atomizing device. A liquid storage chamber for storing cigarette liquid is provided in the atomizing device. The liquid supply device includes a liquid supply member and a connecting member. An inner space of the liquid supply member is a liquid supply chamber containing cigarette liquid. The liquid supply member is provided with a connecting hole. Opposite ends of the connecting member are respectively a liquid inlet end and a liquid outlet end. The liquid inlet end is connected to the connecting hole and communicated with the liquid supply chamber. An interior of the connecting member is a liquid outlet passage. A control valve is provided on the connecting member. When the atomizing device is installed to the liquid outlet end, by operating the control valve, the liquid outlet passage communicates the liquid supply chamber with the liquid storage chamber, or the liquid supply chamber and the liquid storage chamber are cut off by the control valve.

Further, the atomizing device is provided with a through hole. When the atomizing device is installed to the liquid outlet end, the liquid outlet end is connected to the through hole and communicated with the liquid storage chamber.

Further, a sealing member is provided in the through hole to prevent the cigarette liquid in the liquid storage chamber from leaking from the through hole.

Further, when the sealing member is mounted in the through hole, the sealing member is self-sealed, and the outside and the liquid storage chamber are isolated by the sealing member. When the atomizing device is installed to the liquid outlet end, the liquid outlet end penetrates through the sealing member so that the liquid outlet end is communicated with the liquid storage chamber.

Further, the position of the through hole and the position of the connecting hole are at the same height, or the position of the through hole is lower than the position of the connecting hole.

Further, the liquid supply system further includes a sensor and a controller. The sensor is arranged in the liquid supply chamber, the sensor is configured to sense the liquid level value of the cigarette liquid in the liquid supply chamber, and the controller is electrically connected with the sensor and the control valve.

Further, the liquid supply device further includes a base, the liquid supply member and the atomizing device are installed on the base, and the controller is installed in the base.

Further, the atomizing device includes a liquid storage member and an atomizing structure installed on the liquid storage member. The liquid storage chamber is defined in the liquid storage member. The atomizing structure includes an atomizing seat arranged at a lower end of the liquid storage member, a liquid absorbing member received in the atomizing seat, and a heating member arranged in contact with the liquid absorbing member.

In the liquid supply device and the liquid supply system adopting the liquid supply device provided by the present invention, when the atomizing device is installed to the liquid outlet end, the cigarette liquid in the liquid supply chamber can flow into the liquid storage chamber through the liquid outlet passage. The liquid supply device of the present invention can automatically supply liquid to the atomizing device, and the use experience is good.

### BRIEF DESCRIPTION OF THE DRAWINGS

FIG. 1 is a schematic structural view of a liquid supply system in a first embodiment of the present invention;

FIG. 2 is a partially enlarged view of portion A of the liquid supply system shown in FIG. 1;

FIG. 3 is a cross-sectional view of the atomizing main body of the liquid supply system shown in FIG. 1;

FIG. 4 is a cross-sectional view of another viewing angle of the atomizing main body of the liquid supply system shown in FIG. 1; and

FIG. 5 is a schematic structural view of a liquid supply system in a second embodiment of the present invention.

The labels of the components in the figures are as follows:

| | |
|---|---|
| liquid supply system 100 | liquid supply device 10 |
| atomizing device 20 | liquid supply member 11 |
| connecting member 12 | liquid storage chamber 2111 |
| liquid supply chamber 111 | venting hole 112 |
| connecting hole 113 | liquid inlet end 121 |
| liquid outlet end 122 | liquid outlet passage 123 |
| control valve 13 | sensor 30 |
| base 14 | atomizing main body 21 |
| liquid storage member 211 | atomizing structure 212 |
| mouthpiece 213 | through hole 2112 |
| seal member 2113 | air inlet hole 2114 |
| air outlet hole 2115 | air inlet passage 2116 |
| air outlet passage 2117 | atomizing seat 2121 |
| liquid absorbing member 2122 | heating member 2123 |
| liquid seal 2126 | smoke outlet hole 2131 |
| atomizing chamber 2124 | |

### DETAILED DESCRIPTION OF PREFERRED EMBODIMENTS

In order to facilitate the understanding of the present invention, a comprehensive description of the present invention will be given below with reference to the relevant drawings. A preferred embodiment of the present invention is given in the attached figure. However, the present invention can be realized in many different forms and is not limited to the embodiments described herein. On the contrary, the purpose of providing the embodiments is to make the understanding of the disclosure of the present invention more thorough and comprehensive.

It should be noted that, when an element is described as “mounted to” another element, the element may be directly mounted on the another element, or an intermediate element may exist; when an element is described as “connected to” another element, the element may be directly connected to the another element, or an intermediate element may exist.

Unless otherwise defined, all technical and scientific terms used herein have the same meaning as commonly understood by one of ordinary skill in the art to which this disclosure belongs. The terms used herein in the specification of the present disclosure are for the purpose of describing the embodiments only and are not intended to limit the invention. As used herein, the term “and/or” includes any and all combinations of one or more of the associated listed items.

### First Embodiment

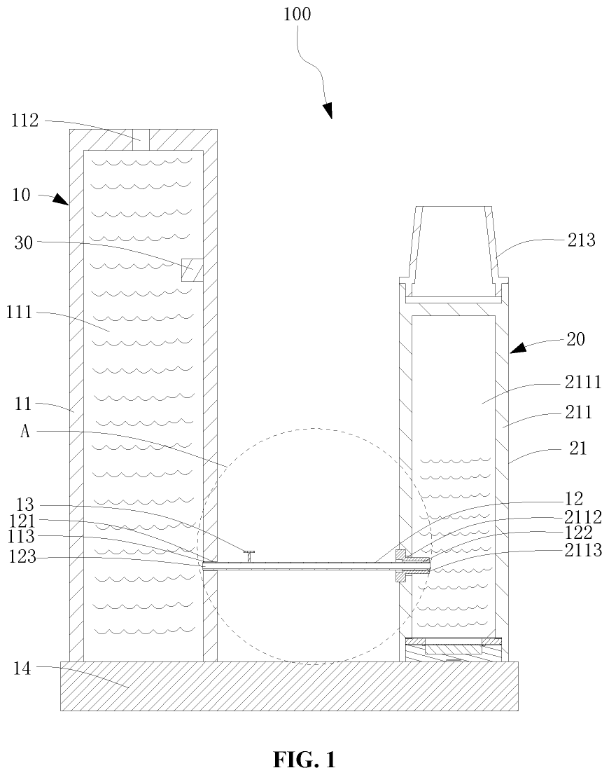

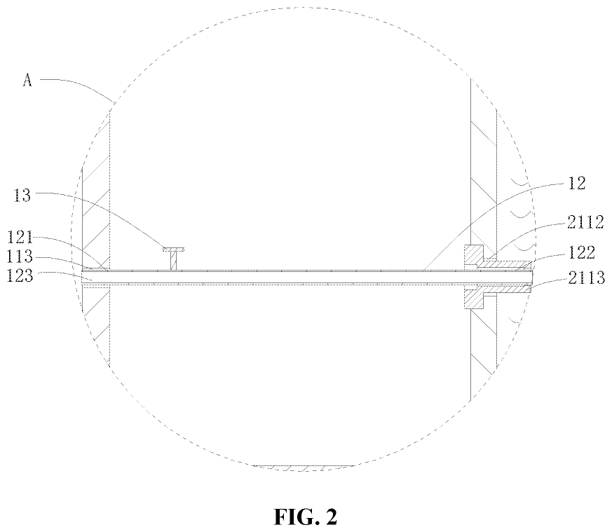

Referring to FIG. 1 and FIG. 2, the first embodiment of the present invention provides a liquid supply system 100. The liquid supply system 100 includes a liquid supply device 10 and an atomizing device 20. The liquid supply device 10 is used for supplying cigarette liquid to the atomizing device 20. Specifically, the liquid supply device 10 includes a liquid supply member 11 and a connecting member 12. The liquid supply member 11 is used for supplying the cigarette liquid, and the connecting member 12 is connected to the liquid supply member 11. A liquid storage chamber 2111 is provided in the atomizing device 20 for storing the cigarette liquid. When the atomizing device 20 is installed to the other end of the connecting member 12 relative to the liquid supply member 11, the liquid supply device 10 can supply the cigarette liquid to the liquid storage chamber 2111 through the connecting member 12.

The liquid supply member 11 has a hollow cylinder structure. The inner chamber of the liquid supply member 11 is a liquid supply chamber 111 for containing the cigarette liquid. A venting hole 112 and a connecting hole 113 are respectively arranged in the liquid supply member 11. The venting hole 112 and the connecting hole 113 both are communicated with the liquid supply chamber 111 and the outside. The venting hole 112 can be defined in the upper portion of a sidewall or at the top of the liquid supply member 11. In this embodiment, the venting hole 112 is defined in the top surface of the liquid supply member 11. The venting hole 112 is used for, when the liquid supply device 10 supplies the cigarette liquid to the atomizing device 20, the external air to enter the liquid supply chamber 111 through the venting hole 112, so as to balance the air pressure inside and outside the liquid supply chamber 111. The connecting hole 113 is defined in the lower portion of a sidewall of the liquid supply member 11, and is used for installing the connecting member 12.

The connecting member 12 is generally a hollow tubular structure. The opposite ends of the connecting member 12 are the liquid inlet end 121 and the liquid outlet end 122. The liquid inlet end 121 is connected with the liquid supply device 10, and the liquid outlet end 122 is connected with the atomizing device 20. Specifically, the atomizing device 20 is provided with a through hole 2112 which communicates the outside and the liquid storage chamber 2111, the liquid inlet end 121 is connected to the connecting hole 113 and communicated with the liquid supply chamber 111. In one embodiment, the position of the through hole 2112 and the position of the connecting hole 113 are at the same height. The liquid inlet end 121 passes through the connecting hole 113 and extends into the liquid supply chamber 111, and the liquid outlet end 122 passes through the through hole 2112 and extends into the liquid storage chamber 2111. The connecting member 12 can be connected to the connecting hole 113 by means of screw connection or interference fit connection, and the connecting member 12 can be attached to the outer wall of the connecting hole 113 or the inner wall of the connecting hole 113. Understandably, in another embodiment not shown, the connecting member 12 can also be integrally formed with the liquid supply member 11.

Specifically, in this embodiment, the connecting member 12 is a straight pipe, and the liquid inlet end 121 and the liquid outlet end 122 are located at the same height.

The interior of the connecting member 12 is a liquid outlet passage 123 communicating the liquid supply chamber 111 with the liquid storage chamber 2111. A control valve 13 is provided on the connecting member 12. When the atomizing device 20 is installed to the connecting member 12, the control valve 13 can be opened or closed by operating the control valve 13. When the control valve 13 is opened, the liquid outlet passage 123 is communicated with the liquid supply chamber 111 and the liquid storage chamber 2111. When the control valve 13 is closed, the liquid supply chamber 111 and the liquid storage chamber 2111 are cut off. Understandably, the ways of operating the control valve 13 include, but are not limited to, manual operation. In the embodiment, the connecting member 12 is made of any hard material such as metal or plastic, so as to facilitate insertion into the liquid storage chamber 2111. In other embodiments, the connecting member 12 is made of flexible material such as plastic hose.

When the atomizing device 20 is installed to the liquid outlet end 122, the liquid outlet passage 123 connects the liquid supply chamber 111 and the liquid storage chamber 2111, and the cigarette liquid in the liquid supply chamber 111 can enter the liquid storage chamber 2111 through the liquid outlet passage 123 due to its own gravity.

Optionally, when the liquid supply device 10 supplies liquid to the atomizing device 20 automatically, in order to make the liquid supply device 10 stop the liquid supply by itself so that it is convenient for operation and improves the user's experience, the liquid supply system 100 may further include a sensor 30 and a controller (not shown). The controller is electrically connected with the sensor 30 and the control valve 13. Specifically, the type of the sensor 30 includes, but is not limited to, a liquid level sensor or a flow sensor. For example, in one embodiment, the sensor 30 is a liquid level sensor, the sensor 30 is arranged in the liquid supply chamber 111, and the sensor 30 is used to detect the liquid level value of the liquid in the liquid supply chamber 111 and transmit the liquid level value to the controller. The type of the controller includes, but is not limited to, a single chip microcomputer. The controller is set with a maximum amount of single liquid supply. The maximum amount of single liquid supply can be a fixed value set by the developer or can be customized by the user. For example, the developer can determine the maximum amount of single liquid supply according to the volume of the liquid storage chamber 2111.

The controller calculates the liquid level difference between the liquid level value in the liquid supply chamber 111 before liquid supply and the liquid level value in the liquid supply chamber 111 after liquid supply. The liquid level difference can be converted into the amount of cigarette liquid supplied from the liquid supply member 11 to the liquid storage chamber 2111. The controller can determine, according to the relationship between the amount of cigarette liquid and the maximum amount of single liquid supply, whether the amount of cigarette liquid supplied by the liquid supply member 11 to the liquid storage chamber 2111 reaches a maximum amount of cigarette liquid flowing from the liquid supply chamber 111 to the liquid storage chamber 2111. For example, if the amount of cigarette liquid reaches the maximum amount of single liquid supply, that is, the amount of cigarette liquid supplied from the liquid supply member 11 to the liquid storage chamber 2111 reaches the maximum amount of cigarette liquid flowing from the liquid supply chamber 111 to the liquid storage chamber 2111, the controller controls the control valve 13 to close, and the liquid supply chamber 111 and the liquid storage chamber 2111 are cut off. If the amount of cigarette liquid does not reach the maximum amount of single liquid supply, the cigarette liquid in the liquid supply chamber 111 is continuously supplied to the liquid storage chamber 2111 until the amount of cigarette liquid reaches the maximum amount of single liquid supply.

For example, in another embodiment not shown, the sensor 30 is a flow sensor, the sensor 30 is arranged in the connecting member 12, and the sensor 30 is used to sense the accumulated flow of the cigarette liquid in the liquid supply chamber 111 through the liquid outlet passage 123. The controller calculates the difference between the detection value of the flow sensor 30 during the liquid supply and the detection value of the flow sensor 30 before the liquid supply, so as to obtain the amount of this liquid supply. The controller is set with a maximum amount of single liquid supply. If the amount of this liquid supply reaches the maximum amount of single liquid supply, that is, the amount of this liquid supply from the liquid supply member 11 to the liquid storage chamber 2111 reaches the maximum amount of cigarette liquid flowing from the liquid supply chamber 111 to the liquid storage chamber 2111, the controller controls the control valve 13 to close, and the liquid supply chamber 111 and the liquid storage chamber 2111 are cut off. If the amount of this liquid supply does not reach the maximum amount of single liquid supply, the cigarette liquid in the liquid supply chamber 111 is continuously supplied to the liquid storage chamber 2111 until the amount of this liquid supply reaches the maximum amount of single liquid supply.

Optionally, in order to facilitate the installation of the controller, the liquid supply device 10 further includes a base 14. Specifically, the base 14 is installed at the lower end of the liquid supply member 11, the controller is installed in the base 14, and the atomizing device 20 is installed on the base 14. It can be understood that the installation position of the atomizing device 20 is not limited, and the atomizing device 20 can be installed at the upper end of the base 14, or at the lower end of the base 14, or on the side of the base 14. Alternatively, in order to make the atomizing device 20 stably installed on the base 14, a groove (not shown) for installing the atomizing device 20 is arranged in the base 14. When the atomizing device 20 is installed in the groove, the atomizing device 20 and the base 14 are fixed in place.

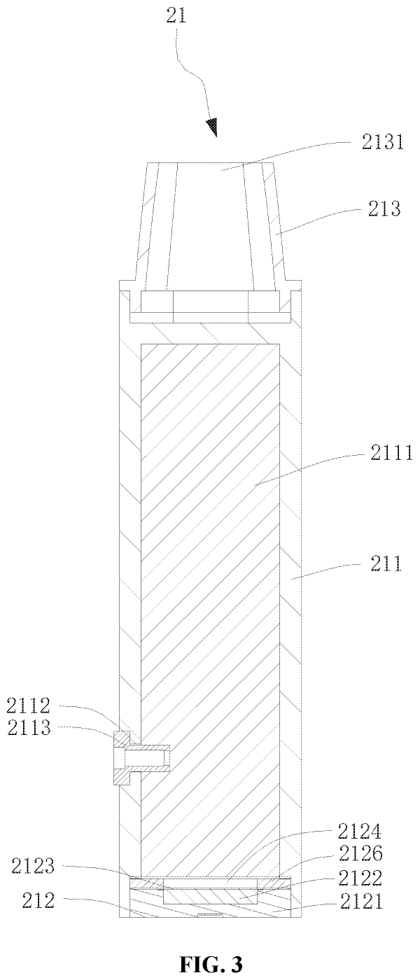

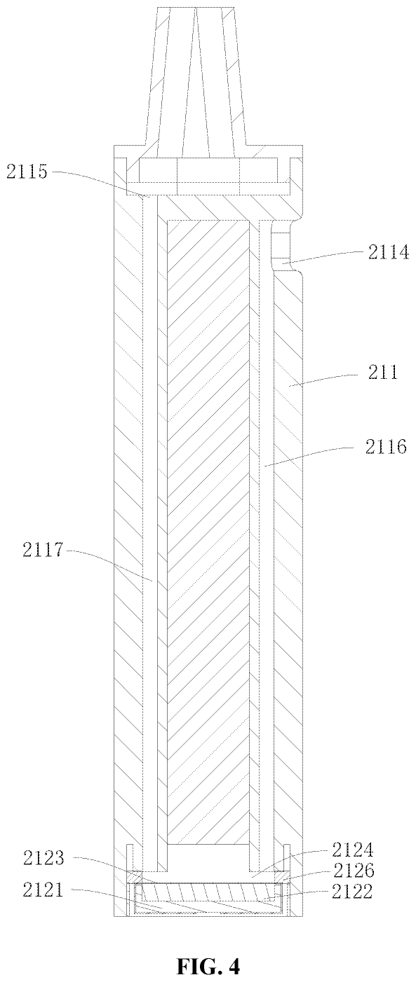

Referring to FIGS. 1-4, the atomizing device 20 includes an atomizing main body 21 and a power supply. The atomizing main body 21 includes a liquid storage member 211, an atomizing structure 212 and a mouthpiece 213. Specifically, the liquid storage member 211 is used for storing the cigarette liquid, the atomizing structure 212 is installed at one end of the liquid storage member 211, and the mouthpiece 213 is installed at the other end of the liquid storage member 211 far away from the atomizing structure 212. The atomizing structure 212 is electrically connected with the power supply. The atomizing structure 212 heats the cigarette liquid stored in the liquid storage member 211 under the electric driving of the power supply. The cigarette liquid is heated to generate smoke, and the smoke flows out of the mouthpiece 213. The user can suck the smoke generated by the atomization through the mouthpiece 213.

The liquid storage member 211 is generally a hollow cylinder structure with an opening at the lower end. The inner space of the liquid storage member 211 is the liquid storage chamber 2111 for storing cigarette liquid. The sidewall of the liquid storage member 211 is provided with the through hole 2112 which communicates the liquid storage chamber 2111 with the outside. The sealing member 2113 is provided in the through hole 2112. The liquid storage member 211 is respectively provided with an air inlet hole 2114 and an air outlet hole 2115 which are communicated with the outside. In the embodiment, the air inlet hole 2114 is arranged in the sidewall of the liquid storage member 211, and the air outlet hole 2115 is arranged in the upper surface of the liquid storage member 211. The liquid storage member 211 is provided with an air inlet passage 2116 and an air outlet passage 2117. Specifically, the sidewall of the liquid storage member 211 at one side of the liquid storage chamber 2111 is provided with an air inlet passage 2116 which is communicated with the air inlet hole 2114 and extends along the axial direction of the liquid storage member 211, and the sidewall of the liquid storage member 211 opposite to the air inlet passage 2116 is provided with an air outlet passage 2117 which is communicated with the air outlet hole 2115 and extends along the axial direction of the liquid storage member 211. That is, the air inlet passage 2116 and the air outlet passage 2117 are oppositely arranged, the liquid storage chamber 2111 is located between the air inlet passage 2116 and the air outlet passage 2117. The liquid storage chamber 2111, the air inlet passage 2116 and the air outlet passage 2117 are isolated from each other.

The sealing member 2113 is connected to the through hole 2112 by a detachable connection such as clamping or inserting. The sealing member 2113 can be a check valve, a valve structure or a plug, etc. The sealing member 2113 is made of silicone, rubber and other elastic materials with good sealing performance.

When the user needs to fill cigarette liquid into the liquid storage chamber 2111, the atomizing main body 21 can be installed to the liquid outlet end 122 by separating the sealing member 2113 and the through hole 2112, so that the liquid outlet end 122 can penetrate the through hole 2112 and extend to the liquid storage chamber 2111. When the liquid outlet passage 123 is connected with the liquid supply chamber 111 and the liquid storage chamber 2111, the cigarette liquid in the liquid supply chamber 111 can enter the liquid storage chamber 2111 through the liquid outlet passage 123. After the user fills the liquid storage chamber 2111 with the cigarette liquid through the through hole 2112, the sealing member 2113 is installed in the through hole 2112 and seals the through hole 2112, to prevent the cigarette liquid in the liquid storage chamber 2111 from leaking from the through hole 2112.

In one embodiment, the sealing member 2113 is a check valve. When there is no internal pressure or the pressure is small, the sealing member 2113 is closed under its own elastic force, and the sealing member 2113 isolates the outside from the liquid storage chamber 2111. As the internal pressure of the sealing member 2113 increases gradually, the sealing member 2113 opens gradually, and the outside can be communicated with the liquid storage chamber 2111 through the sealing member 2113. At this time, the user can fill cigarette liquid directly through the sealing member 2113. Specifically, the liquid outlet end 122 can be inserted into the liquid storage chamber 2111 through the sealing member 2113. After the liquid filling is completed, the atomizing main body 21 is separated from the connecting member 12, and the sealing member 2113 is automatically closed under the effect of its own elastic force to prevent the leakage of the cigarette liquid in the liquid storage chamber 2111.

Referring to FIGS. 1-4, the atomizing structure 212 includes an atomizing seat 2121 arranged at the lower end of the liquid storage member 211, a liquid absorbing member 2122 received in the atomizing seat 2121 and a heating member 2123 arranged in contact with the liquid absorbing member 2122. In the embodiment, the atomizing seat 2121 is used to close the lower opening of the liquid storage member 211, the liquid absorbing member 2122 is disposed on the upper surface of the atomizing seat 2121, and the liquid absorbing member 2122 is arranged under the heating member 2123. When the liquid storage chamber 2111 is filled with the cigarette liquid, the cigarette liquid can flow to the liquid absorbing member 2122 and be absorbed by the liquid absorbing member 2122 smoothly, the liquid absorbing member 2122 will conduct the absorbed cigarette liquid to the heating member 2123, and the heating member 2122 2123 heats and atomizes the cigarette liquid absorbed by the liquid absorbing member 2122. In the embodiment, the space for heating and atomizing the cigarette liquid by the heating member 2123 is an atomizing chamber 2124, the smoke formed by heating the cigarette liquid by the heating member 2123 is mainly located in the atomizing chamber 2124. Specifically, the atomizing chamber 2124 is arranged under the liquid storage chamber 2111, and the atomizing chamber 2124 is communicated with the air inlet passage 2116 and the air outlet passage 2117. It can be understood that in another embodiment not shown, the liquid absorbing member 2122 can also be arranged above the heating member 2123, as long as the liquid absorbing member 2122 can absorb the cigarette liquid.

The liquid absorbing member 2122 is received in the atomizing seat 2121. The liquid absorbing member 2122 is made of cotton, cotton cloth, porous ceramic, or other materials that are easy to absorb liquid. The liquid absorbing member 2122 can absorb the cigarette liquid flowing from the liquid storage chamber 2111 to the liquid absorbing member 2122.

The type of the heating member 2123 can be a heating mesh, a heating plate, etc. The heating member 2123 can be made of stainless steel, nickel chromium alloy, ceramics and other materials. The heating member 2123 is received in the atomizing seat 2121 and covers the liquid absorbing member 2122. In the embodiment, the heating member 2123 is a heating plate. When the heating member 2123 heats and atomizes the cigarette liquid, the external air enters the atomizing chamber 2124 through the air inlet passage 2116 and mixes with the atomized smoke. The smoke mixed with the air enters the air outlet passage 2117 and flows out from the air outlet hole 2115.

Optionally, in order to prevent the cigarette liquid in the liquid storage chamber 2111 from flowing to the outside through the gap between the atomizing seat 2121 and the liquid storage member 211, a liquid seal 2126 is clamped between the atomizing seat 2121 and the liquid storage member 211. The liquid seal 2126 is substantially in a ring shape, and the liquid seal 2126 is made of sealing materials such as silicone or rubber.

The mouthpiece 213 is installed on the liquid storage member 211, and the mouthpiece 213 is provided with a smoke outlet hole 2131 which is communicated with the air outlet hole 2115 and the outside. The user can suck the atomized smoke via the smoke outlet hole 2131. In one embodiment, the mouthpiece 213 and the liquid storage member 211 are two mutually independent components, and the mouthpiece 213 can be detachably connected with the liquid storage member 211 by means of clamping, inserting, etc. Understandably, in another embodiment not shown, the mouthpiece 213 may be integrally formed with the liquid storage member 211.

The power supply is detachable and connected with the atomizing main body 21, so that the positive and negative electrodes of the power supply are respectively connected with two pins of the heating member 2123, and the atomizing main body 21 can heat the cigarette liquid under the electric driving of the power supply and atomize the cigarette liquid into smoke for the user to suck. When the user needs to fill the liquid storage chamber 2111 with the cigarette liquid, the power supply can be separated from the atomizing main body 21, and the atomizing main body 21 can be installed to the liquid outlet end 122. Alternatively, the user can install the atomizing device 20 as a whole to the liquid outlet end 122, as long as the liquid outlet passage 123 can connect the liquid supply chamber 111 with the liquid storage chamber 2111, and the cigarette liquid in the liquid supply chamber 111 can enter the liquid storage chamber 2111 through the liquid outlet passage 123.

In the liquid supply device 10 and the liquid supply system 100 adopting the liquid supply device 10 provided by the present invention, when the atomizing device 20 is installed to the liquid outlet end 122, the cigarette liquid in the liquid supply chamber 111 can flow into the liquid storage chamber 2111 through the liquid outlet passage 123. The liquid supply device 10 of the present invention can automatically supply liquid to the atomizing device 20, and the use experience is good.

### Second Embodiment

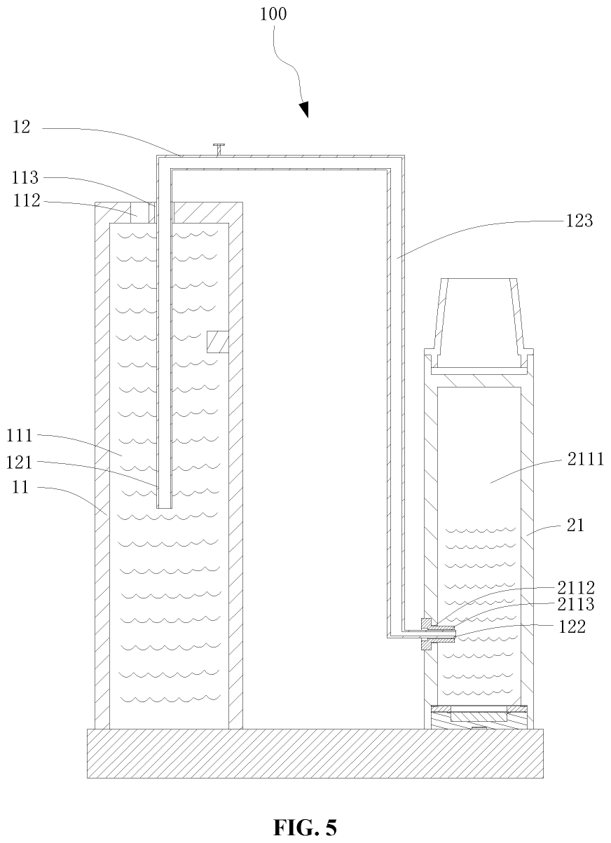

Referring to FIG. 5, the main difference between the liquid supply system 100 provided in the second embodiment and the liquid supply system 100 in the first embodiment is that the connecting hole 113 is defined in the upper surface of the liquid supply member 11, and the position of the connecting hole 113 is higher than the position of the through hole 2112. In addition, the connecting member 12 is a substantially U-shaped pipe, and the liquid outlet end 122 is located at a lower position relative to the liquid inlet end 121. The liquid inlet end 121 passes through the connecting hole 113 and extends into the liquid supply chamber 111, the liquid outlet end 122 passes through the through hole 2112 and extends into the liquid storage chamber 2111, and the cigarette liquid in the liquid supply chamber 111 can enter the liquid storage chamber 2111 through the liquid outlet passage 123 under the siphon principle. Specifically, when the user needs to fill the liquid storage chamber 2111 with the cigarette liquid, the user can pump out the air in the liquid outlet passage 123 from the liquid outlet end 122, so that part of the air in the liquid outlet passage 123 is exhausted to the outside. Thus, the air pressure in the liquid outlet passage 123 is less than the outside air pressure, a negative pressure is generated in the liquid outlet passage 123, and the air pressure near the liquid inlet end 121 in the liquid outlet passage 123 is greater than the air pressure in the liquid outlet end 122, the cigarette liquid in the liquid supply chamber 111 flows from the liquid inlet end 121 to the liquid outlet end 122. At this time, the liquid outlet passage 123 is filled with the cigarette liquid, and the air pressure in the liquid outlet passage 123 is continuously lower than the outside air pressure. The external air cannot enter the liquid outlet passage 123 through the liquid outlet end 122, so that the air pressure in the liquid outlet end 122 is continuously lower than the air pressure in the liquid inlet end 121, and the cigarette liquid in the liquid supply chamber 111 flows continuously from the liquid inlet end 121 to the liquid outlet end 122. At this time, the atomizing main body 21 is installed to the liquid outlet end 122, and the cigarette liquid in the liquid supply chamber 111 can continuously enter the liquid storage chamber 2111.

It can be understood that in another embodiment not shown, the connecting hole 113 can also be arranged in the upper portion of the sidewall of the liquid supply member 11, as long as the position of the connecting hole 113 is higher than the position of the through hole 2112.

Other structural features of the liquid supply system 100 in the second embodiment are the same as those of the liquid supply system 100 in the first embodiment, which will not be repeated here.

The above only describes the embodiments of the present invention, and the description is specific and detailed, but it cannot be understood as the limitation of the protection scope of the present invention. It should be pointed out that for those skilled in the art, on the premise of not departing from the concept of the present invention, modifications and improvements can be made, which belong to the protection scope of the present invention. Therefore, the protection scope of the present invention shall be subject to the appended claims.

What is claimed is:

1. A liquid supply device for supplying liquid to an atomizing device, wherein a liquid storage chamber for storing cigarette liquid is provided in the atomizing device, the liquid supply device comprises a liquid supply member and a connecting member, an inner space of the liquid supply member is a liquid supply chamber containing cigarette liquid, the liquid supply member is provided with a connecting hole, opposite ends of the connecting member are respectively a liquid inlet end and a liquid outlet end, the liquid inlet end is connected to the connecting hole and communicated with the liquid supply chamber, an interior of the connecting member is a liquid outlet passage, a control valve is provided on the connecting member, when the atomizing device is installed to the liquid outlet end, by operating the control valve, the liquid outlet passage communicates the liquid supply chamber with the liquid storage chamber, or the liquid supply chamber and the liquid storage chamber are cut off by the control valve.

2. The liquid supply device according to claim 1, wherein the liquid supply member and the connecting member are integrally formed.

3. The liquid supply device according to claim 1, wherein the liquid supply member is provided with a venting hole communicating the liquid supply chamber with the outside.

4. The liquid supply device according to claim 1, wherein the connecting member is a tubular structure made of hard material.

5. The liquid supply device according to claim 1, wherein the connecting hole is defined in a sidewall of the liquid supply member, the connecting member is a straight pipe, and the liquid inlet end and the liquid outlet end are located at the same height.

6. The liquid supply device according to claim 1, wherein the connecting hole is defined in an upper surface of the liquid supply member, the connecting member is a substantially U-shaped pipe, and the liquid outlet end is located at a lower position relative to the liquid inlet end.

7. A liquid supply system comprising an atomizing device and a liquid supply device configured for supplying liquid to the atomizing device, wherein a liquid storage chamber for storing cigarette liquid is provided in the atomizing device, the liquid supply device comprises a liquid supply member and a connecting member, an inner space of the liquid supply member is a liquid supply chamber containing cigarette liquid, the liquid supply member is provided with a connecting hole, opposite ends of the connecting member are respectively a liquid inlet end and a liquid outlet end, the liquid inlet end is connected to the connecting hole and communicated with the liquid supply chamber, an interior of the connecting member is a liquid outlet passage, a control valve is provided on the connecting member, when the atomizing device is installed to the liquid outlet end, by operating the control valve, the liquid outlet passage communicates the liquid supply chamber with the liquid storage chamber, or the liquid supply chamber and the liquid storage chamber are cut off by the control valve.

8. The liquid supply system according to claim 7, wherein the atomizing device is provided with a through hole, when the atomizing device is installed to the liquid outlet end, the liquid outlet end is connected to the through hole and communicated with the liquid storage chamber.

9. The liquid supply system according to claim 8, wherein a sealing member is provided in the through hole to prevent the cigarette liquid in the liquid storage chamber from leaking from the through hole.

10. The liquid supply system according to claim 9, wherein when the sealing member is mounted in the through hole, the sealing member is self-sealed, and the outside and the liquid storage chamber are isolated by the sealing member; when the atomizing device is installed to the liquid outlet end, the liquid outlet end penetrates through the sealing member so that the liquid outlet end is communicated with the liquid storage chamber.

11. The liquid supply system according to claim 8, wherein the position of the through hole and the position of the connecting hole are at the same height, or the position of the through hole is lower than the position of the connecting hole.

12. The liquid supply system according to claim 7, wherein the liquid supply system further comprises a sensor and a controller, the sensor is arranged in the liquid supply chamber, the sensor is configured to sense the liquid level value of the cigarette liquid in the liquid supply chamber, and the controller is electrically connected with the sensor and the control valve.

13. The liquid supply system according to claim 12, wherein the liquid supply device further comprises a base, the liquid supply member and the atomizing device are installed on the base, and the controller is installed in the base.

14. The liquid supply system according to claim 7, wherein the atomizing device comprises a liquid storage member and an atomizing structure installed on the liquid storage member, the liquid storage chamber is defined in the liquid storage member, the atomizing structure comprises an atomizing seat arranged at a lower end of the liquid storage member, a liquid absorbing member received in the atomizing seat, and a heating member arranged in contact with the liquid absorbing member.
